(19) United States
(12) Patent Application Publication
(10) Pub. No.: US 2006/0111009 A1
(43) Pub. Date: May 25, 2006

(54) System and method of batch manufacturing a display face plate array

(75) Inventors: Shun-Yu Wang, Hsinchu City (TW); Min-Tsung Hsiao, Chunan (TW)

Correspondence Address: C.P. Chang;c/o Pacific Law Group LLP, Suite 525, 224 Airport Parkway, San Jose, CA, 95110, US

(73) Assignee: Taiwan Micro Display Corp., Chunan (TW)

(21) Appl. No.: 10/998,102

(22) Filed: Nov. 24, 2004

(51) Int. Cl. H01J 9/24; H01J 9/46; H01J 9/00

(52) U.S. Cl. 445/66; 445/24

(57) ABSTRACT

A system is disclosed to manufacture an array of multi-layer image display faceplates. Each faceplate has inner dams and outer dams forming irrigation ditches with inlets and outlets for entry and overflow of a bonding resin during its filling into the irrigation ditches. An array bonding mechanism is included for bonding the layers of the faceplate array and a bonding effluent injector array coupled to the inlets and the outlets of the faceplate array for filling the irrigation ditches with the bonding resin. The bonding effluent injector array further includes an array of glue-injecting pipings and glue-returning pipings mechanically and detachably coupled to the inlets and the outlets. A pressurized upstream glue-injecting manifold is coupled to the glue-injecting piping. A downstream glue-returning manifold is coupled to the glue-returning piping for collecting an overflow bonding resin. The system also includes an array curing mechanism for curing the filled bonding resin.

### CROSS REFERENCE TO RELATED APPLICATION

This application relates to a pending U.S. patent application Ser. No. 10/871,477, filed Jun. 18, 2004 by the same assignee, which disclosure is incorporated herein by reference.

### BACKGROUND OF THE INVENTION

1. Field of the Invention

The present invention relates generally to the field of image display devices. More particularity, the present invention is directed to the border frame of a multi-layer image display faceplate and its method of batch manufacturing with an array configuration.

2. Description of the Related Art

Image display devices such as a micro-display device or a Liquid Crystal Display (LCD) panel are widely used in products such as an LCD image projector, a projection TV, a computer display or a display faceplate of a variety of electrical equipments. The underlying principle for the display function is based upon the image display capability of the LCD material. As such, the structural design and associated manufacturing process for these micro-display devices and LCD panels, generally called LCD display faceplates, will directly affect the product quality.

During a traditional manufacturing process of these LCD display faceplates, a wafer is matched with a matrix array glass faceplate, with an LCD layer sandwiched in between, to batch fabricate a multitude of LCD display faceplate units. The wafer has a matrix array corresponding to that of the glass faceplate and each unit of the wafer matrix array has fabricated driving circuitry, typically with an integrated circuit (IC) process, on it for driving the LCD layer to effect an image display. Therefore, during the bonding process of these LCD display faceplates prior to the filling of the effluent LCD material into each display unit, the border frame of each display unit must be delineated to facilitate bonding, LCD material filling and subsequent dicing into individual display units.

FIG. 1A and FIG. 1B are the top view and the corresponding cross sectional structure of a prior art display faceplate A for a single display unit. The display faceplate A has a bordering spacer frame C on top of a wafer B. A glass plate Cl is the cover of the display faceplate A thus defining an interstitial volume F with a gap height G. The formation process of the spacer frame C starts with a routed dispensing of a controlled amount of bonding effluent with an automatic glue-dispensing machine following the route of the spacer frame C. The bonding effluent can be, for example, an epoxy resin or a UV-curable resin for bonding the subsequently overlaid glass plate C1. The glass plate C1 is then placed upon the assembly. A top laminate plate D and a bottom laminate plate E can be bonded to the assembly. Next, the bonding effluent is hardened with a hardening treatment forming the spacer frame C. The interstitial volume F is then filled with a liquid crystal effluent H to complete the cross sectional structure as shown. The above prior art display face plate structure and its associated method of formation have the following disadvantages:
(1) It is not easy to control and accurately position the spacer frame C during the routed dispensing of the bonding effluent. The bonding effluent has a propensity of migrating into either the interstitial volume F or the kerf area of the single display unit causing a yield loss.
(2) As the bonding effluent is not yet hardened while the top laminate plate D and the bottom laminate plate E are being bonded to the assembly, only a limited amount of pressure can be exerted in between. Consequently, the accuracy of the gap height G can not be effectively controlled and this in turn causes a difficulty of controlling the bonding quality of the glass plate C1.
(3) While attempt has been made in the past to improve the above disadvantages by dispersing spacing particles into the bonding effluent so as to improve the accuracy of the gap height G, it was still hard to handle problems caused by the viscosity variation of the bonding effluent. For example, a high viscosity would cause difficulty and/or non-uniformity of spacing particle dispersion. On the other hand, a very low viscosity would cause the spacing particles to either stay afloat the top of or settle to the bottom of the bonding effluent and, in either case, would disable their ability to accurately control the gap height G. Additionally, a mixer equipment needs to be added for the dispersion thus increasing the manufacturing cost.
(4) As the bonding effluent, being the constituent of the spacer frame C, comes in direct contact with the liquid crystal effluent H during its filling into the interstitial volume F, rigorous material compatibility criteria must be met for the selection of the liquid crystal effluent and the resins causing additional burden on manufacturability.

In view of the above disadvantages, it is therefore desirable to devise an improved border frame structure of the multi-layer image display faceplate together with its method of manufacturing. Furthermore, to achieve a low unit manufacturing cost for each such multi-layer image display faceplate, it is important to batch manufacture an array of these multi-layer image display faceplates.

### SUMMARY OF THE INVENTION

A multi-layer image display faceplate and its method of making are proposed. Expressed within an x-y-z coordinate, the display faceplate has successive bonded layers L₁, L₂, . . . , Lⱼ, . . . , L_{N} lying in the x-y plane with at least two successive layers Lₖ and Lₖ₊₁ separated by a gap height Gₖ that, together with a number of spatial sub-zones Zₖ₁, Zₖ₂, . . . , Zₖₘ, . . . , Z_{kP} within Lₖ and Lₖ₊₁, form a corresponding number of interstitial volumes ISₖ₁, ISₖ₂, . . . ISₖₘ, IS_{kP} each of which must be filled with an effluent LCD material for display. Within G_{K} and for each ISₖₘ, the proposed display faceplate includes:
(a) At least one inner dam IDₖₘ bridging Lₖ and Lₖ₊₁ and surrounding thus defining ISₖₘ.
(b) One or more outer dams ODₖ₁, ODₖ₂, . . . , ODₖₙ, . . . , OD_{kQ} located successively away from ISₖₘ and IDₖₘ, where each ODₖₙ forms a wall with a height in the z-direction thus defining a corresponding number of irrigation ditches IRDₖ₁, IRDₖ₂, . . . , IRDₖₙ, . . . , IRD_{kQ}.

Hence, together with Lₖ and Lₖ₊₁, the IDₖₘ enables the filling of the effluent LCD material and the ODₖ₁, ODₖ₂, . . . , ODₖₘ, . . . , OD_{kQ} enable the filling of bonding effluents for bonding Lₖ and Lₖ₊₁ with an accurate gap height G_{K}.

The outer dams can be routed, in the x-y plane, substantially parallel to the inner dam forming a uniform cross section along the corresponding irrigation ditches.

Due to the presence of the inner dam and outer dams, there is no need of spacing particles embedded within the bonding effluents while still maintaining the accurate gap height G_{K}. Due to the presence of the inner dam IDₖₘ, the effluent LCD material and the bonding effluents can be independently selected as they are prevented from contacting each other by the inner dam.

The inner dam IDₖₘ has at least one opening for the entry of the effluent LCD material during its filling into ISₖₘ. Similarly, each outer dam ODₖₙ has at least one opening for the entry of bonding effluents into the irrigation ditch IRDₖₙ. Additionally, each ODₖₙ can have more opening for the exit of bonding effluents during their filling process.

Within some interstitial volume ISₖₘ but near the inner dam opening, a damping wall can be disposed that runs transverse to the effluent flow during its filling process. The damping wall effects a more even and slower effluent LCD material injection into ISₖₘ. The damping wall can be made to bridge Lₖ and Lₖ₊₁ hence further strengthening the support of the gap height G_{K} and improving its dimensional accuracy.

An embodiment of the invention includes the layer Lₖ being a wafer, the layer Lₖ₊₁ being a glass plate, the inner dam and outer dams being a hard solid material such as a metal alloy or polysilicon, the effluent material being a liquid crystal and the bonding effluent being epoxy resin or UV-curable resin.

The method of making the portion of bonded layers Lₖ and Lₖ₊₁ for each interstitial volume ISₖₘ of the multi-layer image display faceplate includes:
(a) Forming, atop the layer Lₖ, at least one inner dam IDₖₘ and the outer dams ODₖ₁, ODₖ₂, . . . , ODₖₙ, . . . , OD_{kQ} with the wall height of the inner dam essentially equal to the gap height G_{K}.
(b) Placing the layer Lₖ₊₁ atop the processed layer Lₖ thus forming the interstitial volume ISₖₘ and covering the irrigation ditches IRDₖ₁, IRDₖ₂, . . . , IRDₖₙ, . . . , IRD_{kQ}.
(c) Filling the ISₖₘ with the effluent LCD material and filling the IRDₖ₁, IRDₖ₂, . . . , IRDₖₙ, . . . , IRD_{kQ} with the bonding effluents to complete the portion of bonded layers Lₖ and Lₖ₊₁.
   Where the damping wall is desired, step (a) of the above method can include a simultaneous formation of the damping wall as well.

Forming the inner dam and the outer dams can be accomplished by plating the hard solid material atop the layer Lₖ followed by patterning the plated hard solid material with a photolithographic process where the plated hard solid material is etched according to a pre-determined geometry of the inner and outer dams.

A system is further proposed to batch manufacture an array of such multi-layer image display faceplates. The proposed system includes an array bonding mechanism for physically handling and bonding the various layers of the display face plate array and a bonding effluent injector array coupled to each of the inlets and the outlets of the display face plate array for filling the irrigation ditches IRDₖₙ with the bonding effluent.

The coupling between the inlets and the outlets and the bonding effluent injector array is effected through its included array of glue-injecting pipings and glue-returning pipings, which in turn are mechanically and detachably coupled to each of the inlets and the outlets.

Corresponding to each glue-injecting piping, the bonding effluent injector array also includes a glue-injecting manifold located upstream of and mechanically coupled to the glue-injecting piping. The glue-injecting manifold contains the bonding effluent and a glue-injecting pump for supplying the bonding effluent through the glue-injecting piping.

Corresponding to each glue-returning piping, the bonding effluent injector array also includes a glue-returning manifold located downstream of and mechanically coupled to the glue-returning piping for collecting an overflow bonding effluent through the glue-returning piping.

The batch manufacturing system also includes an array curing mechanism located in the vicinity of the bonded layers of the display face plate array for curing filled bonding effluent within the irrigation ditches IRDₖₙ hence forming a permanent bond.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become filly appreciated as the same becomes better understood when considered in conjunction with the accompanying drawing, in which like reference characters designate the same or similar parts throughout the several views, and wherein:

FIG. 1A and FIG. 1B are the top view and the corresponding cross sectional structure of a prior art display faceplate for a single display unit;

FIG. 2A illustrates the cross sectional structure of an embodiment of the present invention single display face plate;

FIG. 2B is the top view of the structure of an embodiment of the present invention single display face plate;

FIG. 3 is an embodiment of the present invention method of making a portion of a multi-layer display faceplate;

FIG. 4A is a cross section illustrating a step of the present invention method wherein a hard solid layer is plated onto a wafer;

FIG. 4B is a cross section illustrating a step of the present invention method wherein a photo-resist layer is coated onto the hard solid layer;

FIG. 4C is a cross section illustrating a step of the present invention method wherein the photo-resist layer is being photolithographic patterned by exposure through a photo mask;

FIG. 4D is a cross section illustrating a step of the present invention method wherein the photo-resist layer is being photolithographic patterned by etching through an exposed portion of the photo mask;

FIG. 4E is a cross section illustrating a step of the present invention method wherein a removal region of the hard solid layer is etched away through an etched opening of the photo mask;

FIG. 4F is a cross section illustrating a step of the present invention method wherein an inner dam, an outer dam together with an irrigation ditch are finally formed after the removal of the residual photo mask;

FIG. 5 is a cross section illustrating an alternative step of the present invention method wherein a hard solid layer is plated onto a glass plate;

FIG. 6 is the top view of the structure of another embodiment of the present invention single display face plate;

FIG. 7A is the top view of the structure of an embodiment of the present invention single display face plate wherein a single bonding effluent injector is coupled to a single display face plate for filling the irrigation ditches with the bonding effluent;

FIG. 7B is the top view of the structure of an embodiment of the present invention display face plate array wherein a bonding effluent injector array is coupled to the display face plate array for filling the irrigation ditches with the bonding effluent;

FIG. 8 is an embodiment of the present invention method till the completion of filling the irrigation ditches of the multi-layer display faceplate with the bonding effluent; and

FIG. 9 is a perspective schematic illustration of the batch manufacturing system of the present invention.

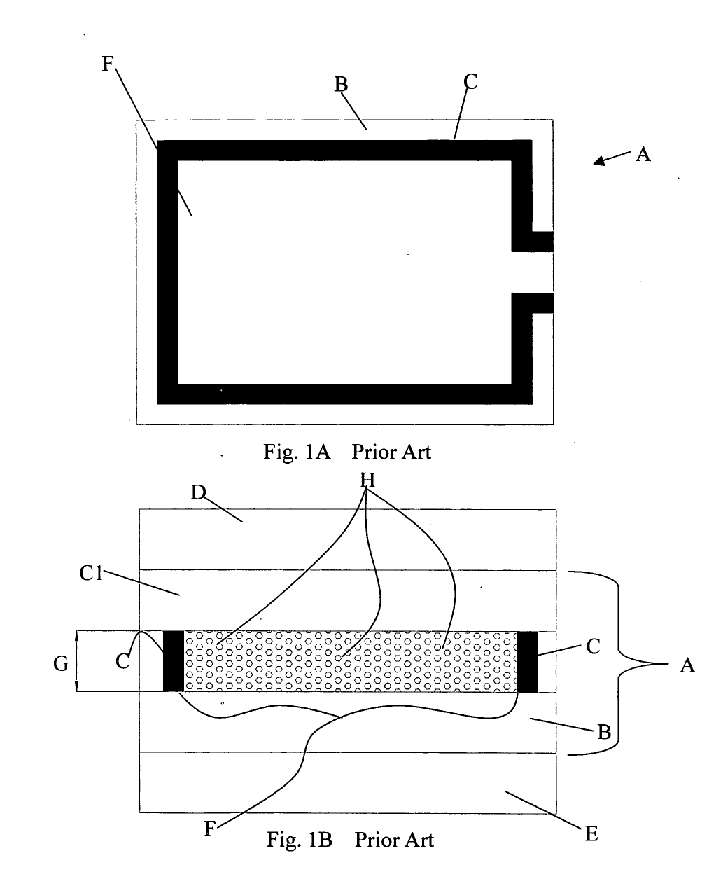

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified perspective views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

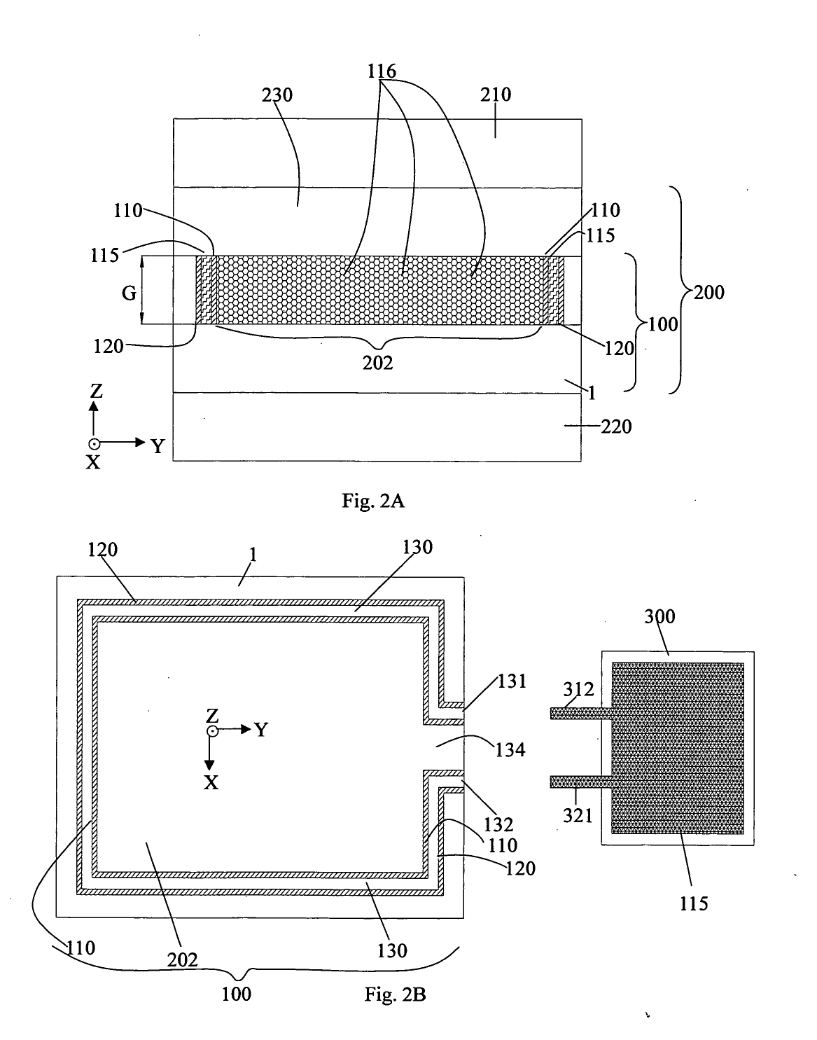

FIG. 2A and FIG. 2B illustrate the cross sectional structure and top view of an embodiment of the present invention single display faceplate 200. A wafer with a border frame 100 forms part of the single display faceplate 200. A method of making the wafer with a border frame 100 will be presently described. The wafer with a border frame 100 has a wafer 1 supporting a pair of inner dam 110 and outer dam 120 running essentially parallel to each other within the x-y plane and generally along the border of the wafer 1 hence defining, together with an upper glass plate 230, an interstitial volume 202 and a irrigation ditch 130. The irrigation ditch 130 functions to fill and hold a resin 115. The inner dam 110, together with the outer dam 120, has an opening 134 along one edge of the wafer 1 for the entry of the effluent liquid crystal 116 during its filling into the interstitial volume 202. Likewise, the irrigation ditch 130 forms two inlets 131 and 132 along one edge of the wafer 1.

As a manufacturing provision, the two inlets 131 and 132 are respectively mated with two glue-injecting pipings 312 and 321 of an externally attached frame glue injector 300 filled with the resin 115 for filling the irrigation ditch 130 with resin 115. While not illustrated here, a configurational variation can provide more openings along the outer dam 120 and use some or all of these openings for the exit of the resin 115 during its filling into the irrigation ditch 130. After the irrigation ditch 130 gets filled with the resin 115, a laminating and bonding process, using a bonding press that is not shown here, follows that bonds an upper bonding plate 210 to the wafer with a border frame 100 through the glass plate 230 and bonds a lower bonding plate 220 beneath the wafer 1. Notice that the glass plate 230 is bonded to the wafer with a border frame 100 with the resin 115. Additionally, owing to the support of the inner dam 110 and the outer dam 120, being both made of a hard solid material, higher pressure can be exerted here between the upper bonding plate 210 and the lower bonding plate 220 thus effecting a positive, accurate fixation of the glass plate 230 onto the top of the wafer with a border frame 100. Consequently, the accuracy of the gap height G is effectively defined and controlled by the height of the inner and outer dams 110 and 120 and the bonding quality of the glass plate C1 is also insured. Clearly this is now accomplished without dispersing any spacing particles into the resin 115 thus significantly saving an associated manufacturing and equipment cost. One other advantage is that, owing to the presence of the inner and outer dams 110 and 120, the material selection for the liquid crystal 116 and the resin 115 are made independent of each other as they are prevented from contacting each other. By the same token, the resin 115 is now positively prevented from migrating into either the interstitial volume 202 or the kerf area of the single display faceplate 200 saving a yield loss. For those skilled in the art, the proposed structure and manufacturing method for the wafer with a border frame 100 as applied to the single display faceplate 200 can be effectively used for a transmission-type micro-display, a reflection-type micro-display or an LCD display with similar advantages.

Following the completion of the laminating and bonding process, the filled resin 115 can be hardened with, for example, a baking process or an Ultra Violet (UV) radiation. The interstitial volume 202 can then be filled with a liquid crystal 116 through the opening 134. The opening 134 is then sealed, although not shown here, to complete the single display faceplate 200.

By now it should become clear that more than one interstitial volume just like the interstitial volume 202 can be incorporated in the single display faceplate 200. It should also be clear that more upper plates in addition to the upper bonding plate 210 and more lower plates in addition to the lower bonding plate 220 can be bonded to the single display faceplate 200 to form a more complex multi-layer display faceplate. Furthermore, these additional upper plates or lower plates can themselves have a structure just the single display faceplate 200 of the present invention. Therefore, in general, the present invention proposes a multi-layer display faceplate for displaying images having a number of successive bonded layers L₁, L₂, . . . , Lⱼ, . . . , L_{N} generally lying in the x-y plane, where N>=2 and wherein at least two successive layers Lₖ and Lₖ₊₁, where 1=<k<N, are separated along the z-direction with a gap height G_{K}. The gap height G_{K}, together with each of a number of spatial sub-zones Zₖ₁, Zₖ₂, . . . , Zₖₘ, . . . , Z_{kP} within the layers Lₖ and Lₖ₊₁ and generally lying in the x-y plane, form a corresponding number of interstitial volumes ISₖ₁, ISₖ₂, . . . , ISₖₘ, . . . , IS_{kP} each of which must be filled with an effluent material to effect a display function. The display faceplate includes, within the gap height G_{K} and for each interstitial volume ISₖₘ:
(1) At least one inner dam IDₖₘ in the form of a wall bridging the layers Lₖ and Lₖ₊₁ and surrounding thus defining the interstitial volume ISₖₙ.
(2) At least one outer dams ODₖ₁, ODₖ₂, . . . , ODₖₙ, . . . , OD_{kQ} located successively away from the interstitial volume ISₖₘ and the inner dam IDₖₘ, where Q>=1, each in the form of a wall with a height in the z-direction thus defining a corresponding number of irrigation ditches IRDₖ₁, IRDₖ₂, . . . , IRDₖₙ, . . . , IRD_{kQ}.
The inner dam IDₖₘ, together with the layers Lₖ and Lₖ₊₁, enables the filling of the effluent material and the outer dams ODₖ₁, ODₖ₂, . . . , ODₖₙ, . . . , OD_{kQ} enable the filling of bonding effluents for bonding the two layers Lₖ and Lₖ₊₁ with an accurate gap height G_{K}.

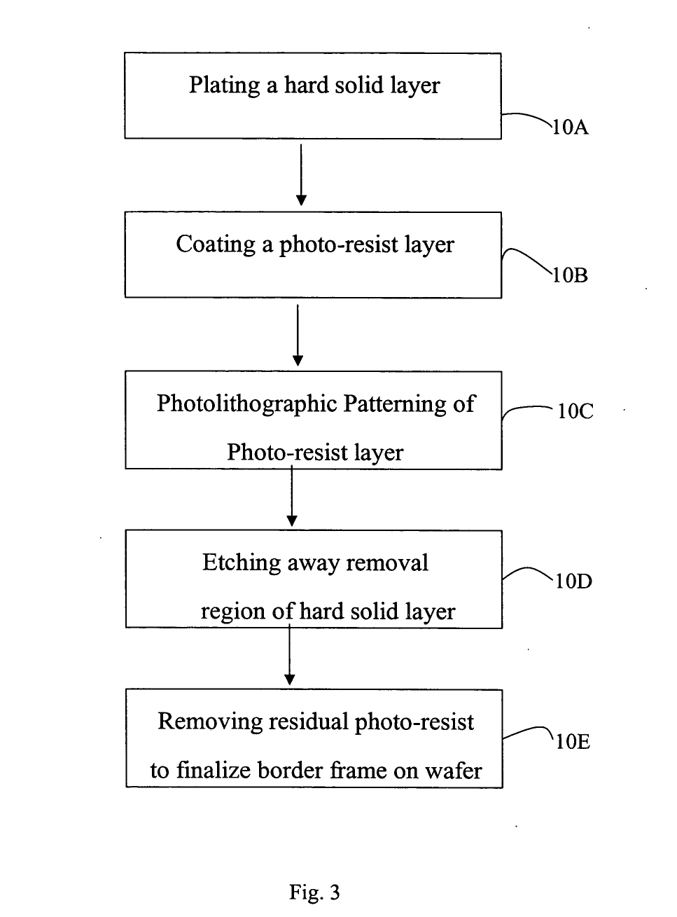

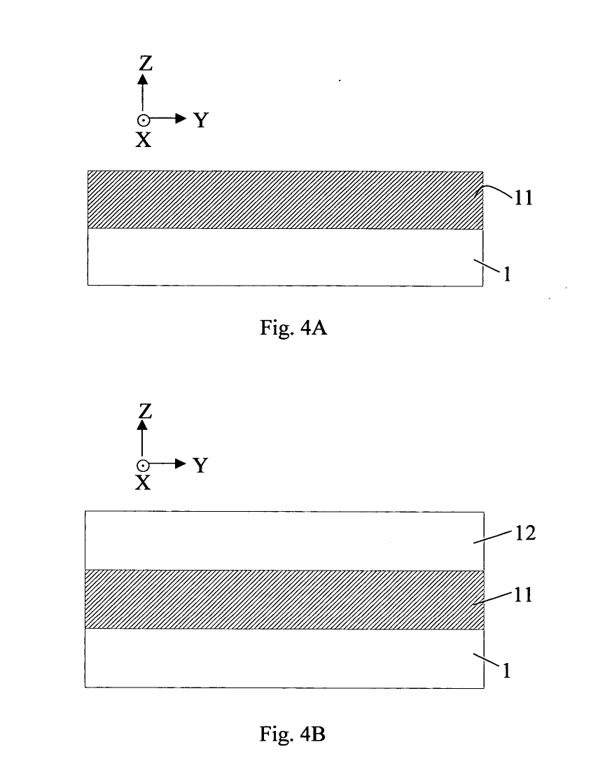

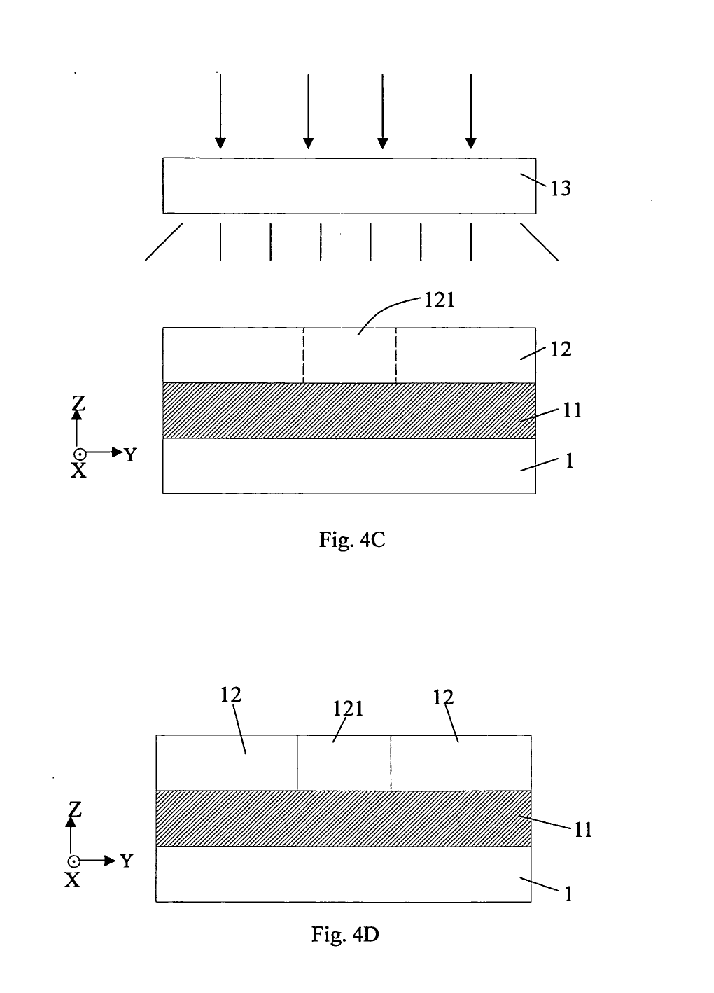

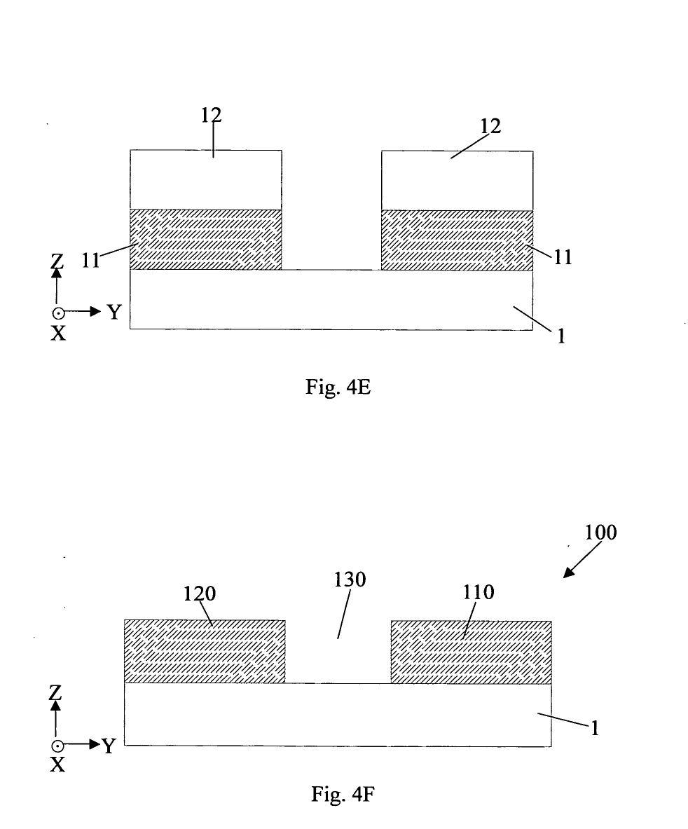

Refer to FIG. 3, FIG. 4A, FIG. 4B, FIG. 4C, FIG. 4D, FIG. 4E and FIG. 4F. FIG. 3 is an embodiment of the present invention method of making the wafer with a border frame 100 that is a portion of a multi-layer display faceplate, in the form of a flow chart with steps 10A through 10E. More specifically:

The step plating a hard solid layer 10A is graphically illustrated in FIG. 4A wherein a hard solid layer 11 is plated on top of a wafer 1. The material for the hard solid layer 11 can be a polysilicon, a metal or an alloy of Aluminum, Copper or Tungsten, etc.

The step coating a photo-resist layer 10B is graphically illustrated in FIG. 4B wherein a photo-resist layer 12 is coated on top of the hard solid layer 11.

The step photolithographic patterning of photo-resist layer 10C is graphically illustrated in FIG. 4C wherein the composite of wafer 1, hard solid layer 11 and photo-resist layer 12 from FIG. 4B is exposed through a photo mask 13 to sensitize a pre-defined removal region of photo-resist layer 121. The removal region of photo-resist layer 121 is then etched away, as illustrated in FIG. 4D, to expose a corresponding surface of the hard solid layer 11.

The step etching away removal region of hard solid layer 10D is graphically illustrated in FIG. 4E wherein the exposed region of the hard solid layer 11 corresponding to the removal region of photo-resist layer 121 is likewise etched away.

The step removing residual photo-resist to finalize border frame on wafer 10E is graphically illustrated in FIG. 4F wherein the residual photo-resist layer 12 covering the hard solid layer 11 from FIG. 4E is again removed with a process similar to the step photolithographic patterning of photo-resist layer 10C. The resulting composite is a wafer with a border frame 100 of the present invention. As illustrated in FIG. 4F, the thus-formed wafer with a border frame 100 includes at least one pair of inner dam 110 and outer dam 120 defining a corresponding irrigation ditch 130 running substantially in the x-direction in this case. The routing of the outer dam 120 in the x-y plane can be, via a corresponding pattern design of the photo-resist layer 12, made substantially parallel to that of the inner dam 110 although this does not have to be the case. Furthermore, depending upon the specific design of the photo mask 13, more than one inner dam and more than one outer dam, located successively away from the interstitial volume 202 and the inner dams can certainly be created to suit additional needs with additional advantages.

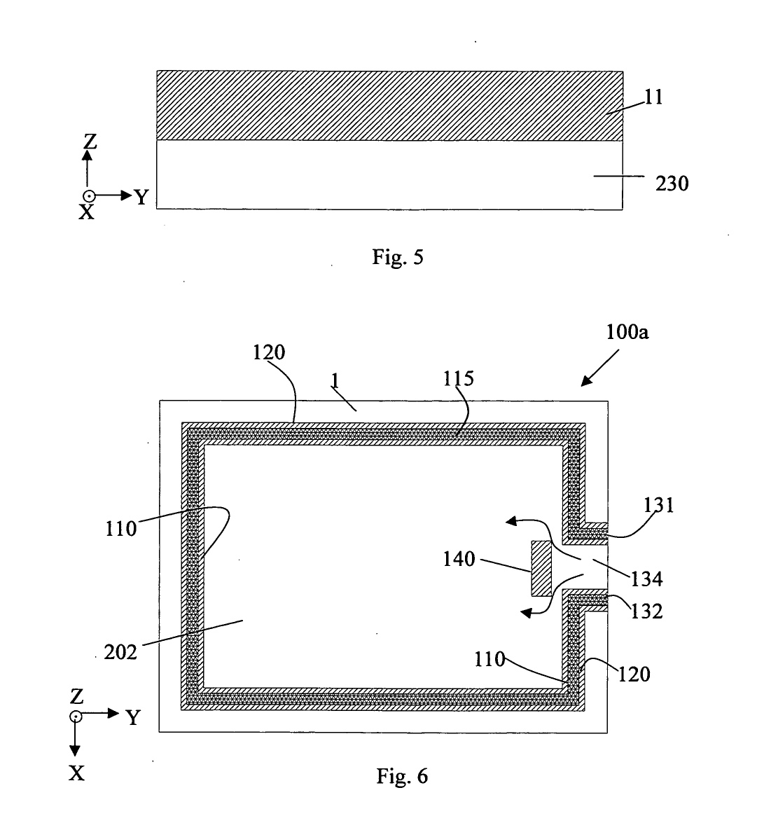

As another embodiment of the present invention, FIG. 5 is a cross section illustrating a variation of the present invention method wherein, instead of the previously illustrated step 10A of plating the hard solid layer 11 onto the wafer 1, the hard solid layer 11 is plated onto the glass plate 230 with the rest of the steps 10B through 10E similar to before with only minor variations for making the wafer with a border frame 100 that is a portion of a multi-layer display faceplate with similar advantages.

Yet another embodiment of the present invention single display faceplate 200 is illustrated in FIG. 6 that is a top view of a wafer with a border frame and damping wall 100a. Within the interstitial volume 202 but near the opening 134 of the inner dam 110, a damping wall 140 is disposed that runs generally transverse to the flow direction of the liquid crystal 116 during its filling process. Thus, during the filling process the damping wall 140 acts to slow down the flow rate and to divide the main flow into sub-flows for a more even and slower LCD effluent injection into the interstitial volume 202 hence avoiding an excessive flow rate that might carry undesirable impurities into the interstitial volume 202. In addition, the height of the damping wall 140, along the z-direction, can be made to bridge the wafer 1 and the glass plate 230 hence further strengthening the support of the gap height G and improving its dimensional accuracy.

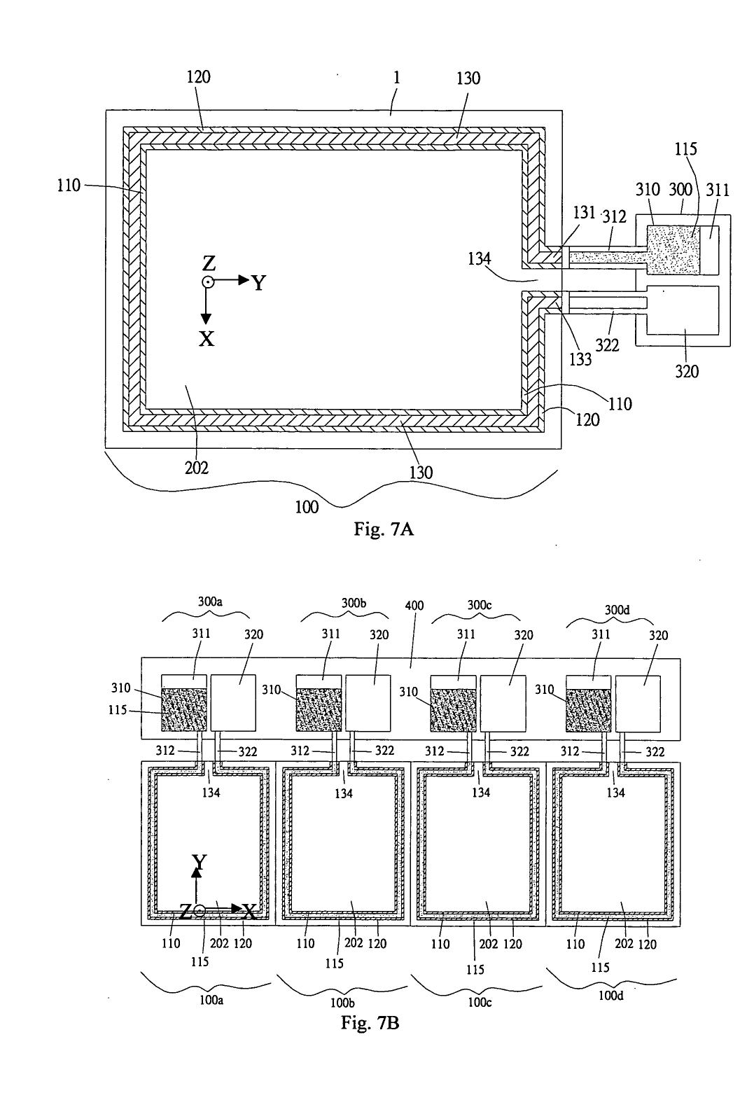

FIG. 7A is the top view of the structure of an embodiment of the present invention single display face plate wherein a single frame glue injector 300 is coupled to a single wafer with a border frame 100 of the display face plate for filling the irrigation ditch 130 with a resin 115 that is the bonding effluent. Notice that except for using one end of the irrigation ditch 130 as an outlet 133, the structure of the wafer with a border frame 100 is the same as that shown in FIG. 2B. Hence, the irrigation ditch 130 functions to fill and hold a resin 115. The inner dam 110, together with the outer dam 120, has an opening 134 along one edge of the wafer 1 for the entry of the effluent liquid crystal 116 during its filling into the interstitial volume 202. However, as a manufacturing provision, the inlet 131 and the outlet 133 are respectively mated with a glue-injecting piping 312 and a glue-returning piping 322 of the single externally attached frame glue injector 300. The frame glue injector 300 has a glue-injecting manifold 310 located upstream of and mechanically coupled to the glue-injecting piping 312. The glue-injecting manifold 310 is filled with the resin 115 that in turn is pressurized by a glue-injecting pump 311 for filling the irrigation ditch 130 with resin 115 through the inlet 131. Meanwhile, the frame glue injector 300 also has a glue-returning manifold 320 located downstream of and mechanically coupled to the outlet 133 for collecting any overflow resin 115 through the glue-returning piping 322.

To effect batch manufacturing of an array of these display faceplates, FIG. 7B illustrates the top view of the structure of an embodiment of the present invention display face plate array wherein a frame glue injector array 400 is coupled to the display face plate array for filling the irrigation ditches with the bonding effluent. In this particular case, the display face plate array has four units of wafer with border frames 100a, 110b, 100c and 100d forming a mechanically integrated array which, after the completion of all manufacturing steps for each display face plate, can then be separated into individual units. Correspondingly, the frame glue injector array 400 is provided with four frame glue injectors 300a, 300b, 300c and 300d respectively coupled to the four units of wafer with border frames 100a, 100b, 100c and 100d thus forming a bonding effluent injecting system that functions, on an individual display face plate basis, the same way as was already described in FIG. 7A. Therefore, the manufacturing efficiency for the display faceplate is correspondingly improved with the frame glue injector array 400. Clearly, the adopted array size can be any number other than the number four as illustrated with its corresponding improvement of manufacturing efficiency. Additionally, for those skilled in the art and within the same general concept of using a frame glue injector array, numerous variations from the specific illustration should become apparent by now. For example, a single glue-injecting manifold or a single glue-injecting pump could be shared amongst several glue-injecting pipings. For another example, a single glue-returning manifold could even be shared amongst all the glue-returning pipings, etc.

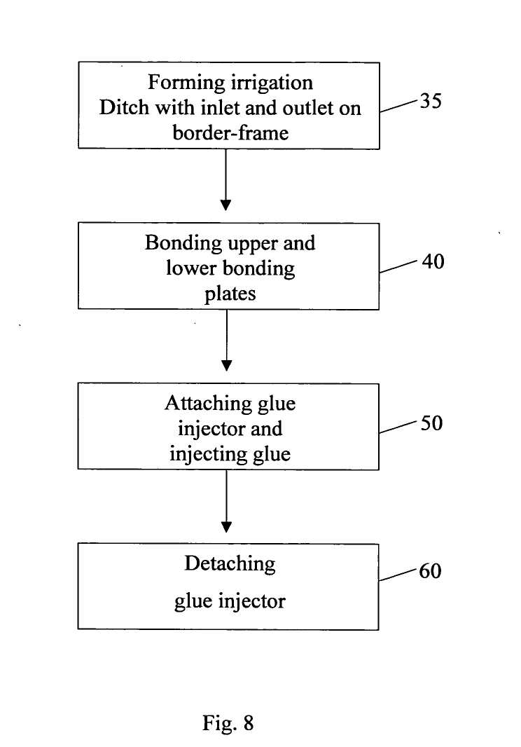

Corresponding to the system for batch manufacturing as illustrated in FIG. 7A and FIG. 7B, FIG. 8 is an embodiment of the present invention method, now carried out on the basis of a display face plate array, till the completion of filling the irrigation ditches of the multi-layer display faceplate array with the bonding effluent. Thus, the details of step forming irrigation ditch with inlet and outlet on border frame 35 and step bonding upper and lower bonding plates 40 were already described earlier. Step attaching glue injector and injecting glue 50 and step detaching glue injector 60 then logically follows with the details of the step attaching glue injector and injecting glue 50 just illustrated in FIG. 7A and FIG. 7B.

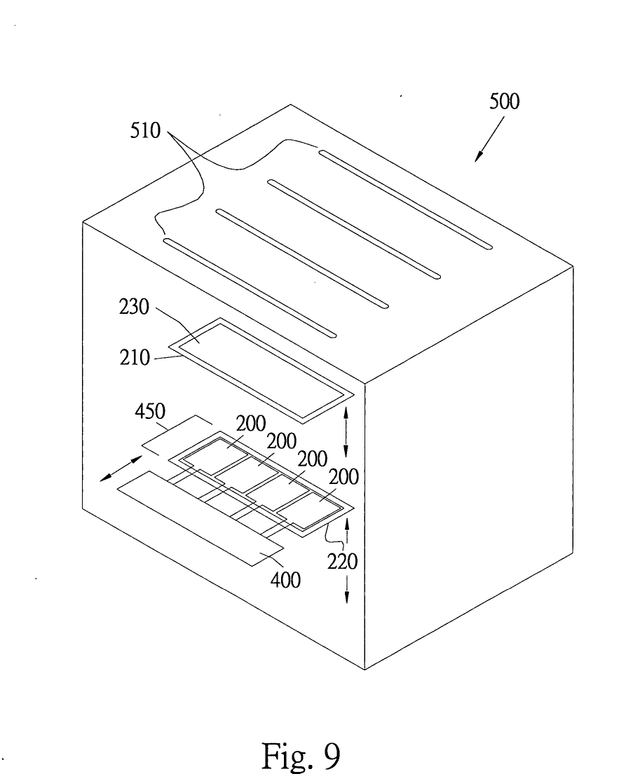

FIG. 9 is a perspective schematic illustration of the batch manufacturing system, in a preferred embodiment of a bonding and curing mechanism 500, of the present invention. To further reduce parts handling and manufacturing cost of the display face plate array, the afore-described frame glue injector array 400 is now integrated within the bonding and curing mechanism 500. As its name suggests, the bonding and curing mechanism 500 also includes an integrated mechanism, whose details are not shown here to avoid unnecessarily obscuring the nature of the present invention, for bonding the lower bonding plate 220, the upper bonding plate 210 and the glass plate 230 of numerous single display faceplates 200 within a display face plate array 450 following essentially a vertical work movement. Notice that, to avoid mechanical interference, the attachment and detachment of glue injector within the frame glue injector array 400 follow essentially a horizontal work movement. Additionally, the bonding and curing mechanism 500 includes, near its top, a UV-curing apparatus 510 for irradiating hence hardening the filled resin 115 inside the irrigation ditches of the display faceplate array 450. Clearly, the bonding and curing mechanism 500 can be extended so as to bond all necessary layers of the display faceplate array. Also, additional mechanism for filling the interstitial volume 202 with a liquid crystal material through the effluent entry 134 can optionally be integrated with the bonding and curing mechanism 500.

As described with numerous exemplary embodiments, a multi-layer image display faceplate together with a system are proposed to batch manufacture an array of multi-layer image display faceplates where each display faceplate has a number of inner dams IDₖₘ and a number of outer dams ODₖₙ forming a number of irrigation ditches IRDₖ₁, IRDₖ₂, . . . , IRDₖₙ, . . . , IRD_{kQ} with at least one inlet and at least one outlet for the entry and exit of a bonding resin during its filling into the irrigation ditches IRDₖₙ. The proposed system includes an array bonding mechanism for physically handling and bonding the various layers of the display face plate array and a bonding effluent injector array coupled to each of the inlets and the outlets of the display face plate array for filling the irrigation ditches IRDₖₙ with the bonding resin. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A system for batch manufacturing a display face plate array having, expressed with x-y-z Cartesian coordinates, a number of multi-layer image display face plates Lⱼ, j=1 . . . N, generally lying in the x-y plane, wherein at least two layers Lⱼ, and Lⱼ₊₁ are separated, after being bonded with a bonding effluent, along z-direction with a gap height G_{K} that, together with a number of spatial sub-zones Zₖₘ, m=1 . . . p, within the layers Lⱼ and Lⱼ₊₁, form interstitial volumes ISₖₘ each filled with a display effluent, said each ISₖₘ further surrounded by at least one inner dam IDₖₘ with at least one display effluent entry and at least one outer dams ODₖₙ, n=1 . . . Q, located successively away from said ISₖₘ and said IDₖₘ, each outer dam defining a corresponding irrigation ditch IRDₖₙ with at least one inlet openings and at least one outlet openings for the entry and exit of said bonding effluent, the batch manufacturing system comprises:
(a) an array bonding means for handling and bonding said successive layers Lⱼ of said display face plate array; and
(b) a bonding effluent injector array for filling said IRDₖₙ with said bonding effluent.

2. The batch manufacturing system of claim 1 wherein said bonding effluent injector array, further comprises an array of glue-injecting pipings and glue-returning pipings mechanically and detachably coupled to each of the inlets and the outlets of said display.

3. The batch manufacturing system of claim 2 wherein said bonding effluent injector array, corresponding to each glue-injecting piping, further comprises a glue-injecting manifold located upstream of and mechanically coupled to said glue-injecting piping to contain said bonding effluent.

4. The batch manufacturing system of claim 3 wherein said glue-injecting manifold further comprises a glue-injecting pump for supplying the bonding effluent through the glue-injecting piping.

5. The batch manufacturing system of claim 2 wherein said bonding effluent injector array, corresponding to each glue-returning piping, further comprises a glue-returning manifold, located downstream of and mechanically coupled to said glue-returning piping, for collecting an overflow bonding effluent through the glue-returning piping.

6. The batch manufacturing system of claim 1 further comprises an array curing means, located in the vicinity of the bonded successive layers L₁, L₂, . . . , L₃, . . . , L_{N}, for curing filled bonding effluent within said irrigation ditches IRDₖₙ thereby forming a permanent bond between said layers Lₖ and Lₖ₊₁.

7. The batch manufacturing system of claim 1 wherein said layer Lₖ is a wafer, said layer Lₖ₊₁ is a glass plate and said effluent material is a liquid crystal.

8. The batch manufacturing system of claim 1 wherein said at least one inner dam IDₖₘ and said outer dams ODₖ₁, ODₖ₂, . . . , ODₖₙ, . . . , OD_{kQ} are made of a hard solid material.

9. The batch manufacturing system of claim 6 wherein said hard solid material is metal, metal alloy or polysilicon.

10. The batch manufacturing system of claim 7 wherein the components of said metal alloy are selected from the group consisting of Aluminum, Copper and Tungsten.

11. The batch manufacturing system of claim 1 wherein said bonding effluent is epoxy resin or UV-curable resin.

12. A method of batch manufacturing a display face plate array having, expressed with x-y-z Cartesian coordinates, a number of multi-layer image display face plates Lⱼ, j=1 . . . N, generally lying in the x-y plane, wherein at least two layers Lⱼ, and Lⱼ₊1 are separated, after being bonded with a bonding effluent, along z-direction with a gap height G_{K} that, together with a number of spatial sub-zones Zₖₙ, m=1. . . p, within the layers Lⱼ and Lⱼ₊1, form interstitial volumes ISₖₘ each must be filled with a display effluent, said each ISₖₘ further surrounded by at least one inner dam IDₖₘ with at least one display effluent entry and at least one outer dams ODₖₙ, n=1 . . . Q, located successively away from said ISₖₙ and said IDₖₘ, each outer dam defining a corresponding irrigation ditch IRDₖₙ with at least one inlet openings and at least one outlet openings for the entry and exit of said bonding effluent, the batch manufacturing method comprises:
(a) bonding said successive layers L₁, L₂, . . . , Lⱼ, . . . , L_{N} of said display face plate array; and
(b) batch filling said irrigation ditches IRDₖₙ of each of said display faceplate of said display faceplate array with said bonding effluent.

13. The batch manufacturing method of claim 12 further comprises batch curing filled bonding effluent within said irrigation ditches IRDₖₙ thereby forming a permanent bond between said layers Lₖ and Lₖ₊₁.

14. The batch manufacturing method of claim 13 wherein said layer Lₖ is a wafer, said layer Lₖ₊₁ is a glass plate and said effluent material is a liquid crystal.

15. The batch manufacturing system of claim 12 wherein said at least one inner dam IDₖₘ and said outer dams ODₖ₁, ODₖ₂, . . . , ODₖₙ, . . . , OD_{kQ} are made of a hard solid material.

16. The batch manufacturing system of claim 15 wherein said hard solid material is metal, metal alloy or polysilicon.

17. The batch manufacturing system of claim 16 wherein the components of said metal alloy are selected from the group consisting of Aluminum, Copper and Tungsten.

18. The batch manufacturing system of claim 12 wherein said bonding effluent is epoxy resin or UV-curable resin.
